(19) United States
(12) Patent Application Publication
(10) Pub. No.: US 2025/0007366 A1
(43) Pub. Date: Jan. 2, 2025

(54) GROUNDING BRUSH ASSEMBLY

(71) Applicant: AKTIEBOLAGET SKF, GOTEBORG (SE)

(72) Inventors: Anthony SIMONIN, Tours (FR); Thomas PERROTIN, Saint Roch (FR); Emmanuel BENEVISE, Monts (FR); Benoit ARNAULT, Saint-Cyr-sur-Loire (FR)

(21) Appl. No.: 18/745,057

(22) Filed: Jun. 17, 2024

(30) Foreign Application Priority Data
Jun. 30, 2023 (FR) 2306928

(51) Int. Cl. H02K 11/40; H01R 39/38

(52) U.S. Cl. CPC H02K 11/40; H01R 39/385

(57) ABSTRACT

A grounding brush assembly includes a grounding brush, the brush having a support and a plurality of conductive disposed at least partially within the support, and a brush mounting plate rigidly secured to the support of the brush. The grounding brush is preferably formed as an open ring and has first and second ends facing each other and spaced circumferentially apart. The mounting plate includes at least one anti-rotation lug disposed within the circumferential space separating the first and second ends of the grounding brush.

### CROSS-REFERENCE

This application claims priority to French patent application no. 2306928 filed on Jun. 30, 2023, the contents of which are fully incorporated herein by reference.

### BACKGROUND OF THE INVENTION

The present invention relates to the field of grounding devices for controlling the shaft voltage generated in electric motors or machines, and in particular grounding brush assemblies.

In an electric motor or machine, at least one rolling bearing is mounted between a casing of the electric motor/machine and a rotary shaft in order to rotatably support the shaft.

During operation when the shaft rotates, a difference in electrical potential between the shaft and the casing of the electric motor or machine may arise, which may generate an electric current between an inner ring of the rolling bearing, which is rigidly secured to the shaft, and an outer ring of the bearing, which is rigidly secured to the casing.

Electrical current passing through the components of the rolling bearing can damage these components, in particular the rolling elements and the raceways formed on the inner and outer rings. Electrical discharges can also generate vibration.

To overcome these drawbacks, it is a known practice to ground or earth the rotary shaft using a grounding brush comprising conductive fibers. The grounding brush is usually mounted in the bore of the casing of the electric motor such that the free ends of the fibers are in radial contact with the outer surface of the rotary shaft.

Due to the conductivity of the fibers, the brush is maintained at the same electrical potential as the casing of the electric motor. The inner and outer rings of the rolling bearing are also at the same electrical potential, which reduces or even eliminates problematic electrical discharges through the rolling bearing.

US Patent Publication No. 2021/0021180 A1 discloses a grounding brush assembly comprising a grounding brush having a plurality of conductive fibers and a support inside of which the conductive fibers are mounted, and an annular mounting plate including a plurality of tabs for radial and axial retention of the support and an annular outer flange radially surrounding the brush and the tabs.

With such a grounding brush assembly, during operation of the electric machine when the shaft rotates, there may be a loss of contact between the mounting plate and the support, which limits or prevents the passage of electric current through the assembly.

### SUMMARY OF THE INVENTION

The present invention aims to overcome the drawback discussed above.

Specifically, the present invention relates to a grounding brush assembly comprising a grounding brush provided with a plurality of conductive fibers and with a support inside which the conductive fibers are mounted. The assembly further comprises a brush mounting plate which is rigidly secured to the support of the brush.

The grounding brush takes the form of an open ring having a first end and with a second end spaced apart from the first end, the ends facing one another circumferentially.

The first and second ends define the circumferential length of the brush.

According to a general feature, the mounting plate comprises at least one anti-rotation lug disposed within a circumferential space separating the first and second ends of the grounding brush.

The lug of the mounting plate forms a means for blocking rotation of the brush in the event of circumferential movement of the brush with respect to the mounting plate. The lug enables blocking of rotation of the brush by making contact in the circumferential direction with one of the two ends of the brush.

Such blocking of brush rotation prevents the risk of wear by friction, heating between the mounting plate and the support of the brush, and electro-erosion which can lead to a loss of contact between the mounting plate and the support. The passage of electric current through the assembly is thus reliably ensured during machine operation.

No additional means on the mounting plate and/or on the brush is necessary to perform the anti-rotation function by axial interference.

The mounting plate may include a plurality of retention tabs for retaining the support of the brush. Preferably, the anti-rotation lug of the mounting plate is distinct from the retention tabs.

The mounting plate may include an annular radial portion against which the grounding brush bears axially. In this case, the support of the brush may bear axially against the radial portion of the mounting plate.

In a particular embodiment, the retention tabs of the mounting plate extend from the radial portion of the mounting plate. Alternatively, the retention tabs of the mounting plate may extend from another portion of the mounting plate.

In an embodiment, the mounting plate further includes at least one centering portion extending at least axially from the radial portion, offset radially outwardly with respect to the support and having an outer surface defining an outside diameter of the mounting plate.

According to one embodiment, the anti-rotation lug extends from the radial portion of the mounting plate. Alternatively, the anti-rotation lug may extend from another portion of the mounting plate, for example from the retention tabs or from the centering portion.

Preferably, the mounting plate is made in one piece.

Advantageously, the anti-rotation lug of the mounting plate is formed at least by plastic deformation of the mounting plate. The anti-rotation lug may be formed by cutting and plastic deformation of the mounting plate, such as by means of a stamping operation.

Alternatively, the mounting plate may be formed by other manufacturing methods, for example by additive manufacturing, in other words by any manufacturing method based on the construction of the mounting plate layer by layer by the addition of material. In such a case, the anti-rotation lug or lugs are obtained during the manufacturing of the mounting plate.

The present invention also relates to an electric motor comprising a casing, a shaft and at least one grounding brush assembly as defined above and mounted radially between the casing and the shaft, the conductive fibers of the brush of the assembly being in contact with the shaft.

### BRIEF DESCRIPTION OF THE SEVERAL VIEWS OF THE DRAWINGS

The present invention will be understood more clearly on reading the detailed description of embodiments, provided by way of non-limiting examples and illustrated by the attached drawings in which:

FIG. 1 is a view in axial cross section of a grounding brush assembly mounted radially between a rotary shaft and a casing of an electric motor;

FIG. 2 is a front perspective view of a grounding brush assembly according to a first exemplary embodiment of the invention;

FIG. 3 is a rear perspective view of the grounding brush assembly according to the first exemplary embodiment of the invention;

FIG. 4 is an end-on view of the grounding brush assembly of FIGS. 2 and 3;

FIG. 5 is a view in cross section along the axis V-V of FIG. 4;

FIG. 6 is a perspective view of a grounding brush assembly according to a second exemplary embodiment of the invention;

FIG. 7 is an end-on view of the grounding brush assembly of FIG. 6;

FIG. 8 is a perspective view of a grounding brush assembly according to a third exemplary embodiment of the invention;

FIG. 9 is an end-on view of the grounding brush assembly of FIG. 8;

FIG. 10 is a rear perspective view of a grounding brush assembly according to a third exemplary embodiment of the invention;

FIG. 11 is a front perspective view of a grounding brush assembly according to a third exemplary embodiment of the invention;

FIG. 12 is an end-on view of the grounding brush assembly of FIGS. 10 and 11.

### DETAILED DESCRIPTION OF THE INVENTION

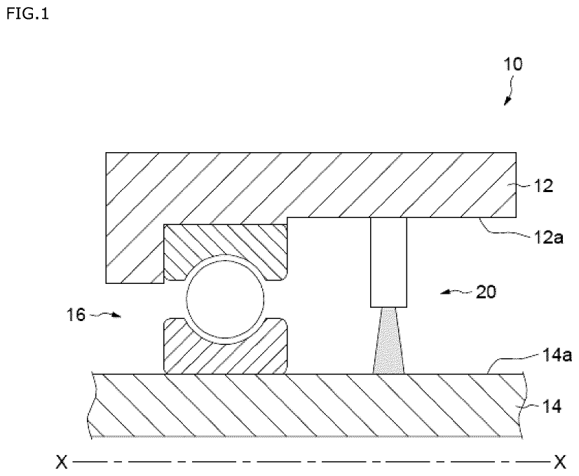

FIG. 1 shows, in axial cross section, part of an electric motor or machine 10 comprising a fixed casing 12, a shaft 14 rotatable about a central axis X-X and supported radially by a rolling bearing 16. The bearing 16 is depicted as a ball bearing, but may have any other types of rolling elements (e.g., cylindrical rollers, tapered rollers, etc.) and may even be formed as a plain bearing.

The motor 10 further comprises a grounding brush assembly 20 mounted radially between the bore 12a of the casing 12 and the cylindrical outer surface 14a of the rotary shaft 14.

The grounding brush assembly 20 enables a continuous dissipation of electrical charges that build up on the shaft 14 of the motor 10 during motor operation by transferring these charges to the casing 12.

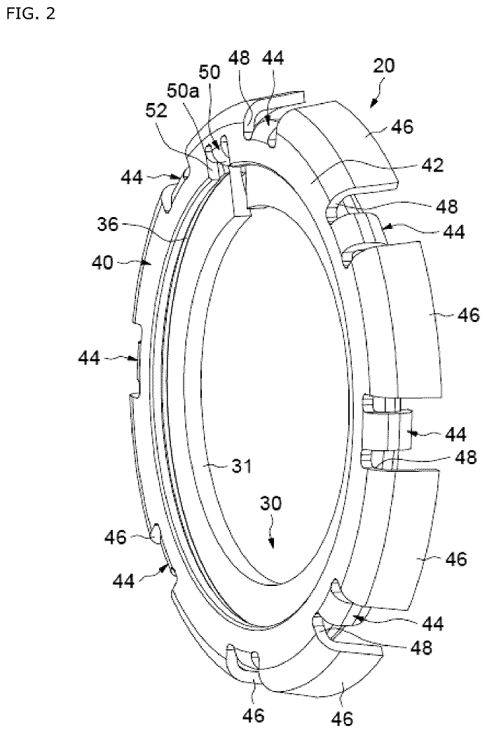

With reference to FIGS. 2-5, a grounding brush assembly 20 according to a first example will now be described.

The grounding brush assembly 20 has a generally annular shape and basically comprises a grounding brush 30 and a brush mounting plate 40 configured to axially and radially retain the brush 30.

As will be described in more detail below, the brush mounting plate 40 is also configured to block rotation of the brush 30.

The brush 30 comprises a plurality of individual conductive fibers 31 intended to be positioned around the rotary shaft 14 of the motor 10. The conductive fibers 31 may be fabricated from an appropriate conductive material such as carbon, stainless steel, a conductive plastic such as acrylic or nylon fibers, or any other appropriate material.

The brush 30 further includes a holding member or support 32 inside of which the conductive fibers 31 are mounted; that is, the conductive fibers 31 are at least partially disposed within the support 32. In the depicted exemplary embodiment, the support 32 is generally formed as an open ring. The support 32 may be produced by cutting and shaping or bending. The support 32 is made of an electrically conductive material, for example aluminum, stainless steel, bronze, copper or another appropriate material. Alternatively, the support 32 may be made of an electrically non-conductive material with a conductive coating or a conductive paint applied to the support 32.

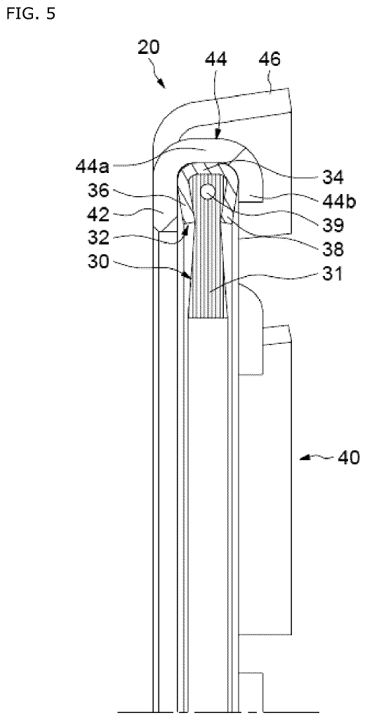

As best shown in FIG. 5, the support 32 includes an axial mounting portion 34 and two opposite lateral flanks 36, 38 extending radially inwardly from the mounting portion 34 and axially gripping the conductive fibers 31. The conductive fibers 31 bear axially on either side against the lateral flanks 36, 38.

The mounting portion 34 and the two lateral flanks 36, 38 delimit a channel that is open radially inward, inside of which the conductive fibers 31 are at least partially located.

In the example shown, the conductive fibers 31 are bent around a connecting wire 39 of the support 32. The free distal end of the conductive fibers 31 is intended to come into radial contact with the outer surface of the rotary shaft 14 of the motor 10. The proximal end of the conductive fibers 31 is in radial contact with the mounting portion 34 of the support 32.

The lateral flank 36 extends from one axial end of the mounting portion 34 and the lateral flank 38 extends from an opposing axial end of the mounting portion 34. The lateral flanks 36, 38 extend obliquely inwardly from the mounting portion 34 and are symmetrical with respect to each other about a median radial plane of the support 32. Preferably, the mounting portion 34 extends substantially axially, but the mounting portion 34 may alternatively extend obliquely. As a further alternative, the lateral flanks 36, 38 may be non-symmetrical.

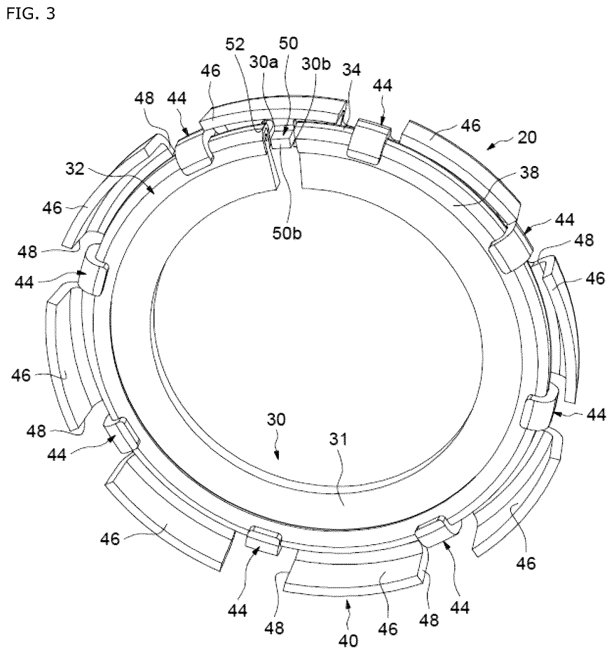

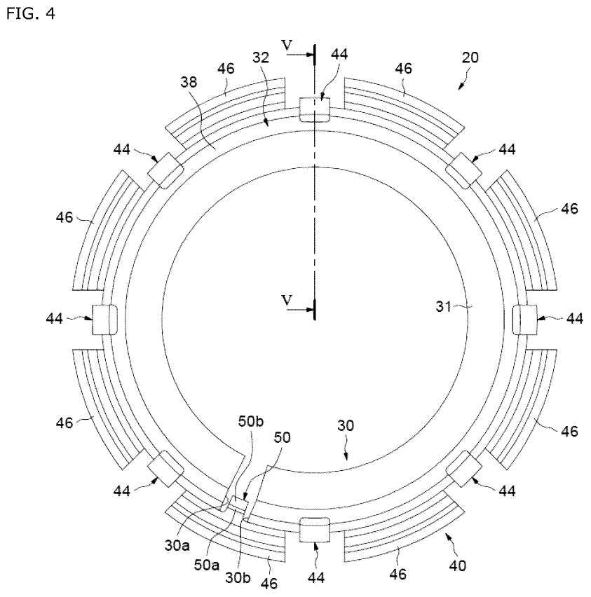

As stated above, the brush 30 is generally formed as an open ring and has a first end 30a and an opposite, second end 30b spaced apart circumferentially from the first end 30a, as particularly shown in FIGS. 3 and 4. The first and second ends 30a, 30b are circumferentially spaced apart from one another, such a circumferential spacing between two ends 30a, 30b of the brush 30 enabling the brush 30 to adapt to different diameters of a motor shaft 14.

In general, the first end 30a of the brush 30 and the second end 30b of the brush 30 are not attached to each other. Alternatively, the first and second ends 30a, 30b of the brush 30 may be attached.

In the depicted exemplary embodiment, each of the first and second ends 30a, 30b of the brush 30 is formed both by the conductive fibers 31 and by the support 32. Alternatively, each one of the first and second ends 30a, 30b may be formed only by the conductive fibers 31 or by the support 32, if the conductive fibers 31 protrude circumferentially with respect to the support 32 or vice versa.

The brush mounting plate 40 includes an annular radial portion 42 and a plurality of tabs 44 for axial and radial retention of the brush 30, the tabs 44 extending from the radial portion 42.

The mounting plate 40 may be produced by cutting and shaping, such as by means of a stamping operation. The mounting plate 40 is made of an electrically conductive material, for example aluminum, stainless steel, bronze, copper or another appropriate material. Alternatively, the mounting plate 40 may be made of an electrically non-conductive material with a conductive coating or a conductive paint applied to the plate 40.

The radial portion 42 of the mounting plate 40 bears axially against the support 32 of the brush 30. More specifically, the radial portion 42 bears axially against the lateral flank 36 of the support 32.

The tabs 44 are spaced apart from one another in the circumferential direction, in this case regularly or evenly, but may alternatively be irregularly or unevenly circumferentially spaced. In the depicted exemplary embodiment, the mounting plate 40 has eight tabs 44. Alternatively, the mounting plate 40 may have more than eight tabs 44 or less than eight tabs 44. For example, the mounting plate 40 may have two tabs 44 or four tabs 44. Preferably, the plate 40 has at least two tabs 44.

Each tab 44 protrudes or projects axially relative to the radial portion 42. Each tab 44 locally radially surrounds the support 32 of the brush 30 and is in radial contact with the mounting portion 34 of the support 32. The support 32 is held axially bearing against the radial portion 42 of the mounting plate 40 by the tabs 44. As such, the tabs 44 enable axial and radial retention of the grounding brush 30 on the mounting plate 40. The lateral flank 36 of the support 32 bears against the radial portion 42 of the mounting plate 40 and the lateral flank 38 bears against the tabs 44. The tabs 44 are preferably generally identical to each other.

As can be seen more clearly in FIG. 5, each tab 44 includes an axial portion 44a, which extends axially from the radial portion 42, radially locally surrounds the support 32 and is in radial contact with the support 32, and a radially inwardly bent portion 44b provided at the free end of the axial portion 44a. The bent portion 44b of each tab 44 enables axial retention of the support 32 of the grounding brush 30. The bent portion 44b of each tab 44 is in axial contact against the lateral flank 38 of the support 32.

The brush mounting plate 40 further includes a plurality of centering lugs 46 extending from the radial portion 42 of the plate 40 and spaced apart from one another in the circumferential direction. A plurality of notches 48 are formed on the radial portion 42, each notch 48 being defined between each consecutive pair of lugs 46. Preferably, the lugs 46 are formed by cutting and bending the radial portion 42.

Each lug 46 extends at least axially from the radial portion 42. Specifically, the lugs 46 extend obliquely from a large-diameter edge of the radial portion 42. Preferably, the lugs 46 and the tabs 44 extend axially from the same axial side of the radial portion 42. Alternatively, the tabs 44 may extend from one axial side of the radial portion 42 and the lugs 46 may extend from an opposing side of the radial portion 42.

Each lug 46 locally radially surrounds and is radially spaced from the support 32 of the brush 30. The lugs 46 are offset radially outwardly with respect to the tabs 44. Preferably, the lugs 46 are formed substantially identical to each other. The lugs 46 define an outside diameter of the mounting plate 40. Preferably, each lug 46 extends obliquely but may alternatively extend substantially axially. Each lug 46 is preferably formed as a portion of a cylinder. The bore of each lug 46 is spaced apart radially from the support 32 by a non-zero radial distance. The outer surfaces of the lugs 46 define the outside diameter of the mounting plate 40. The lugs 46 enable centering of the mounting plate 40 after mounting the grounding brush assembly 20 within the bore 12a of the casing 12 of the associated electric motor 10.

As shown in FIGS. 2-4, the lugs 46 are spaced apart from one another in the circumferential direction, in this case regularly or evenly. Alternatively, the lugs 46 may be circumferentially spaced irregularly or unevenly. Each lug 46 is circumferentially located between two consecutive tabs 44 and each lug 46 is spaced apart, in the circumferential direction, from each of the two immediately adjacent tabs 44. Preferably, each lug 46 has a circumferential dimension which is greater than a circumferential dimension of each one of the tabs 44.

As stated above, the brush mounting plate 40 is also configured to block rotation of the brush 30. To achieve this function, the mounting plate 40 further includes an anti-rotation lug 50 extending into the circumferential space separating the first and second ends 30a, 30b of the brush 30. The lug 50 extends from the radial portion 42 of the plate 40 and protrudes axially relative to the radial portion 42. The lug 50 extends circumferentially within the space separating the first and second ends 30a, 30b of the brush 30.

The anti-rotation lug 50 circumferentially faces the first and second ends 30a, 30b of the brush 30. A circumferential clearance is provided between the lug 50 and the first end 30a of the brush and another circumferential clearance is provided between the lug 50 and the second end 30b of the brush 30. These clearances enable the brush 30 to remain adaptable to different diameters of the shaft 14 of the motor 10.

The anti-rotation lug 50 is distinct from the tabs 44. The lug 50 is located, in the circumferential direction, between two successive tabs 44.

The anti-rotation lug 50 is preferably formed by cutting and bending the radial portion 42 of the mounting plate 40. A window 52 is formed on the radial portion 42 during the cutting of the plate 40 to create the lug 50. The window 52 is in this case a “through window”. The window 52 extends axially through a thickness of the radial portion 42 and the window 52 opens radially inwardly.

In the depicted exemplary embodiment, the lug 50 includes a radially-inwardly bent portion 50a extending from the radial portion 42 of the mounting plate 40 and an axial portion 50b extending from the bent portion 50a and lying in or disposed within the circumferential space separating the first and second ends 30a, 30b of the brush 30.

In the depicted exemplary embodiment, one of the lugs 46 locally radially surrounds the anti-rotation lug 50. In this embodiment, the root of the lug 50 is located radially on the periphery of the radial portion 42 of the mounting plate 40. In other words, the root of the lug 50 is located radially on the same side as the large-diameter edge of the window 52. Alternatively, the lug 50 may be formed on the radial portion 42 of the plate 40 such that the root of the lug 50 is located radially on the inner side of the radial portion 42. In this case, the root of the lug 50 would extend from a small-diameter edge of the window 52 and the window would not open radially inwardly.

If the brush 30 moves circumferentially with respect to the mounting plate 40, the anti-rotation lug 50 of the plate 40 blocks any further rotation of the brush 30 by making contact in the circumferential direction against either the first end 30a of the brush 30 or the second end 30b of the brush 30.

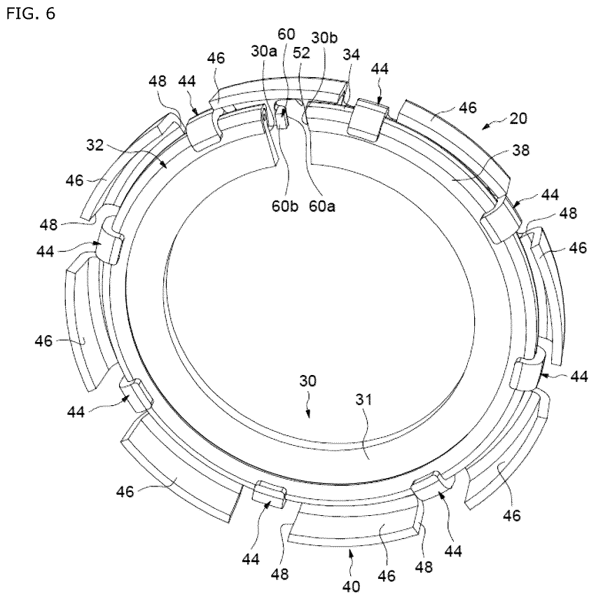

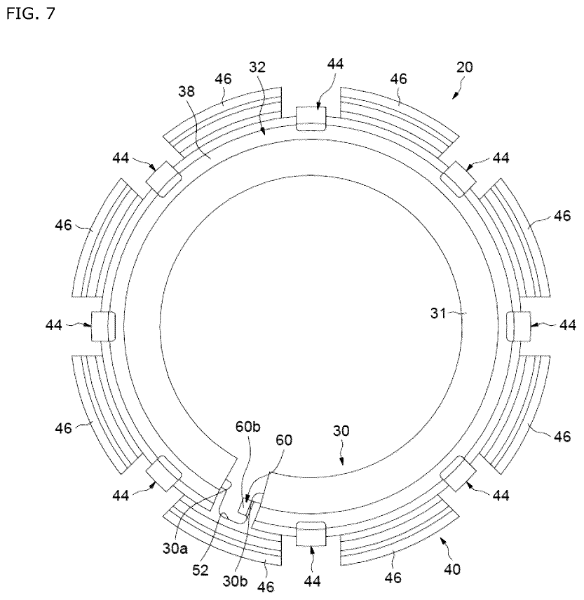

The exemplary embodiment illustrated in FIGS. 6 and 7, in which identical elements bear the same reference numbers, differs from the first example discussed above in that the mounting plate 40 comprises an anti-rotation lug 60 extending from one of two lateral edges of the window 52. The root of the lug 60 thus extends in this case from one lateral edge of the window 52.

The lug 60 protrudes axially relative to the radial portion 42. The lug 60 lies in, or is disposed within, the circumferential space separating the first and second ends 30a, 30b of the brush 30. The lug 60 includes an axially bent portion 60a extending from the lateral edge of the window 52 and an axial portion 60b extending from the bent portion 60a and disposed within the circumferential space separating the first and second ends 30a, 30b of the brush 30.

The anti-rotation lug 60 circumferentially faces the first and second ends 30a, 30b of the brush 30. A circumferential clearance is provided between the lug 60 and the first end 30a of the brush 30 and another circumferential clearance is provided between the lug 60 and the second end 30b of the brush 30, the width or length of these two clearances being different in FIGS. 6 and 7. Alternatively, the size of each clearance may be made to be equal.

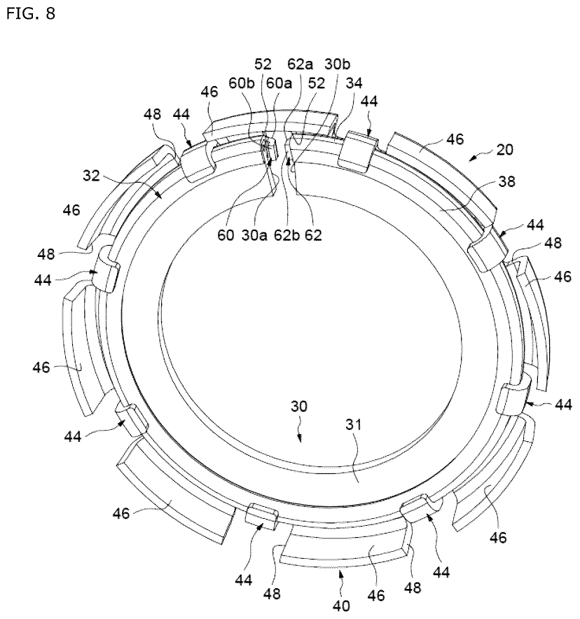

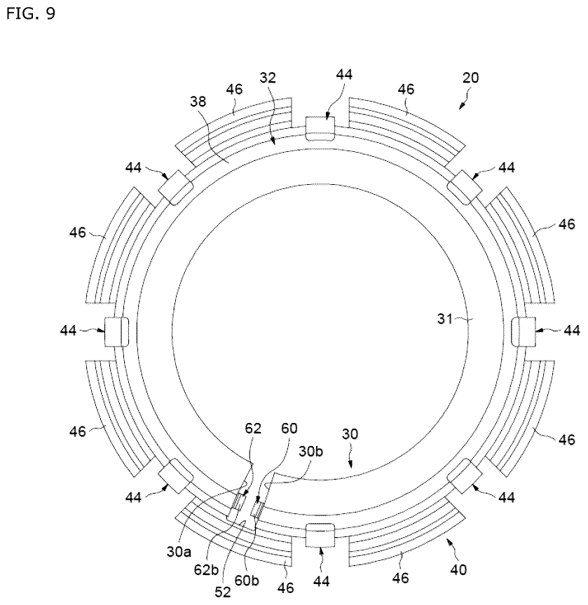

The exemplary embodiment illustrated in FIGS. 8 and 9, in which identical elements bear the same reference numbers, differs from the preceding exemplary embodiment in that the mounting plate 40 comprises an additional anti-rotation lug 62 extending from the lateral edge of the window 52 opposite to the edge from which extends the lug 60. The additional anti-rotation lug 62 also lies in the circumferential space separating the first and second ends 30a, 30b of the brush 30.

The lug 62 protrudes axially relative to the radial portion 42 of the mounting plate 40. The lug 62 includes an axially bent portion 62a which extends from the lateral edge of the window 52 opposite to the lug 60 and an axial portion 62b extending from the bent portion 62a and disposed within the circumferential space separating the first and second ends 30a, 30b of the brush 30.

The anti-rotation lug 60 circumferentially faces the first end 30a of the brush 30 and the other anti-rotation lug 62 circumferentially faces the second end 30b of the brush 30 while being located at a distance therefrom.

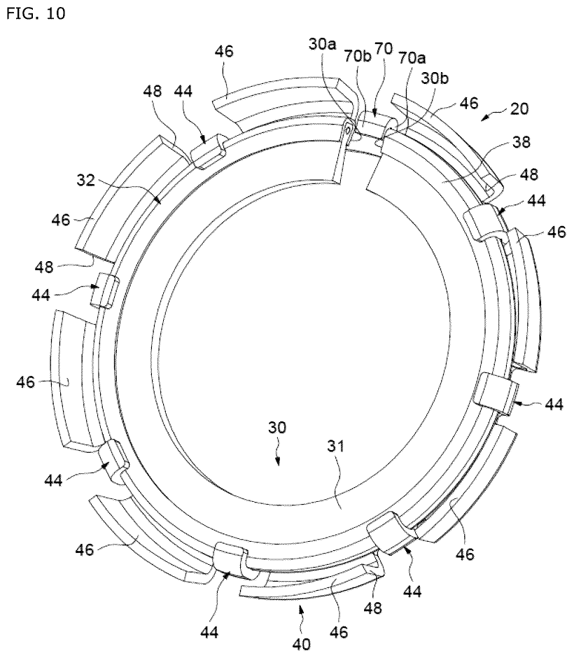

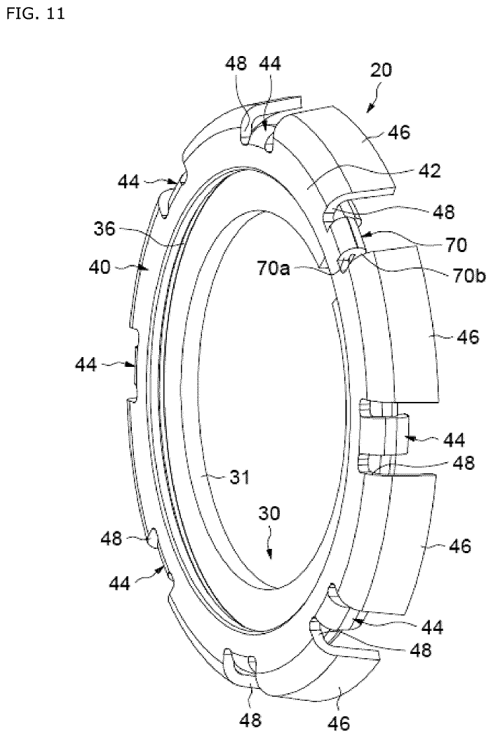

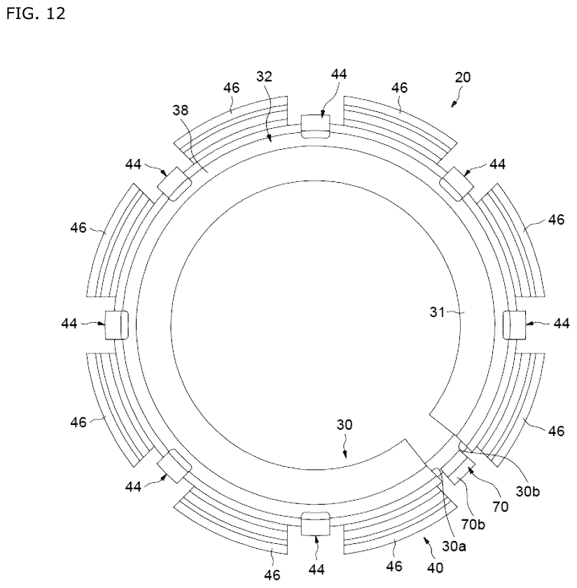

The exemplary embodiment illustrated in FIGS. 10 to 12, in which identical elements bear the same reference numbers, differs from the first example described above in that the mounting plate 40 includes an anti-rotation lug 70 extending from the radial portion 42 and bent upon on itself and upon the radial portion 42 so as to locally form a double thickness of material.

The anti-rotation lug 70 is disposed within the circumferential space separating the first and second ends 30a, 30b of the brush 30. The lug 70 protrudes axially relative to the radial portion 42 of the mounting plate 40. The lug 70 lies circumferentially in the circumferential space separating the first and second ends 30a, 30b of the brush 30. The lug 70 includes a radial portion 70a extending radially outwardly from the radial portion 42 of the plate 40 and a bent portion 70b extending from the radial portion 70a and bent axially against the radial portion 70a. Alternatively, the radial portion 70a of the lug 70 could extend radially inwardly.

The bent portion 70b of the anti-rotation lug 70 is disposed within the circumferential space separating the first and second ends 30a, 30b of the brush 30. The lug 70 circumferentially faces the first and second ends 30a, 30b of the brush 30. A circumferential clearance is provided between the lug 70 and the first end 30a of the brush 30 and another circumferential clearance is provided between the lug 70 and the second end 30b of the brush 30. In this exemplary embodiment, the lug 70 is located circumferentially between two successive lugs 46.

In the embodiments illustrated, each anti-rotation lug or lugs 50, 60, 62, 70 of the mounting plate 40 is circumferentially spaced from each one of the first and second ends 30a, 30b of the grounding brush 30. Alternatively, it would be possible to provide for the anti-rotation lug or lugs 50, 60, 62 or 70 of the mounting plate 40 to be in contact with one of the ends 30a, 30b of the grounding brush 30 or with both of the ends 30a, 30b of the brush 30.

In the illustrated embodiments, each lug 50, 60, 62 or 70 of the mounting plate 40 protrudes axially with respect to the lateral flank 36 of the support 32 but is axially set back with respect to the lateral flank 38 (i.e., is spaced axially from the flank 38). Alternatively, the one or more lugs 50, 60, 62 or 70 may also protrude axially with respect to the lateral flank 38 of the support 32.

In the embodiments illustrated, the mounting plate 40 of the grounding brush assembly 20 includes a plurality of centering lugs 46. Alternatively, the lugs 46 may be replaced by a single annular flange forming an annular centering portion (not shown).

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A grounding brush assembly comprising:
a grounding brush including a support and a plurality of conductive fibers disposed at least partially within the support, the grounding brush being formed as an open ring having a first end and a second end, the first and second ends being spaced circumferentially apart and facing each other so as to define a circumferential space; and
a brush mounting plate rigidly secured to the support of the brush and having at least one anti-rotation lug disposed within the circumferential space separating the first and second ends of the grounding brush.

2. The grounding brush assembly according to claim 1, wherein the mounting plate includes a plurality of retention tabs for retaining the support of the brush.

3. The grounding brush assembly according to claim 2, wherein the at least one anti-rotation lug of the mounting plate is distinct from the retention tabs.

4. The grounding brush assembly according to claim 1, wherein the mounting plate includes an annular radial portion and the grounding brush bears axially against the radial portion.

5. The grounding brush assembly according to claim 4, wherein the at least one anti-rotation lug extends from the radial portion of the mounting plate.

6. The grounding brush assembly according to claim 4, wherein the mounting plate includes a plurality of retention tabs for retaining the support of the brush extending from the radial portion of the mounting plate.

7. The grounding brush assembly according to claim 4, wherein the support of the brush bears axially against the radial portion of the mounting plate.

8. The grounding brush assembly according to claim 4, wherein the mounting plate includes at least one centering portion extending at least axially from the radial portion, offset radially outwardly with respect to the support and having an outer surface defining an outside diameter of the mounting plate.

9. The grounding brush assembly according to claim 1, wherein the anti-rotation lug is formed at least by plastic deformation of the mounting plate.

10. An electric motor comprising:
a casing;
a shaft; and
at least one grounding brush assembly according to claim 1 mounted radially between the casing and the shaft, the conductive fibers of the brush of the assembly being in contact with the shaft.
